(19) United States
(12) Patent Application Publication
(10) Pub. No.: US 2006/0118574 A1
(43) Pub. Date: Jun. 8, 2006

(54) Method for filling a bag and for dispensing a beverage from said bag

(76) Inventors: Ian Anderson, Burwell (GB); Stephen J. Grimwade, Upwood (GB)

Correspondence Address: James W Kerr;Interbrew SA, 303 Richmond Street, London, ON, N6B 2H8, CA

(21) Appl. No.: 10/536,972

(22) PCT Filed: Nov. 25, 2003
(86) PCT No.: PCT/IB03/05405

§ 371 Date: Feb. 1, 2006

(30) Foreign Application Priority Data
Nov. 29, 2002 (GB) 0227932.1
Nov. 29, 2002 (GB) 0227933.9
Nov. 29, 2002 (GB) 0227939.6
Nov. 29, 2002 (GB) 0227945.3
Oct. 24, 2003 (GB) 0324901.8

(51) Int. Cl. G01F 11/00

(52) U.S. Cl. 222/1

(57) ABSTRACT

A method is provided for filling a bag with an alcohol beverage inflates the bag with an inert gas prior to filing the bag with the beverage. The inert gas is vented from the bag as the bag is filled with the beverage. By initially inflating the bag with the inert gas, the bag is not inflated during the step of filling the bag with the beverage and hence, the bag is less susceptible to rupture during beverage filling the inert gas acts to purge any air trapped in the bag. During the venting step the inert gas and air mixture is vented from the bag. There is less chance for air to be trapped in the bag and spoil the beverage in the bag. In a further aspect, the bag is contained in a container and the air between the container and the bag is also evacuated. The inert gas may be CO₂ or nitrogen when the beverage is beer. Also provided is a valve and valve and spear assembly for alcohol dispensing apparatus.

### FIELD OF THE INVENTION

The present invention relates to a method of filling a bag with an alcohol beverage and in particular, relates to a method of filling a bag contained in a container such as a keg with beer. The present invention further relates to a valve assembly and a valve and spear unit assembly both adapted for filling a bag with an alcohol beverage when the bag is contained in a container.

### BACKGROUND OF THE INVENTION

It is known to contain alcohol, such as wine in bags contained in a cardboard type container. Further, it is known to use a bag inserted into a keg for storing beer in the bag. In the case of a beer keg, pressure is applied to the bag to dispense the beer from the bag and out of the keg. Further, the bag is inserted into the keg container prior to the beer being filled into the bag.

The filling of beer into the bag, has two potential problems. One problem is that the bag still may contain air that mixes with the beer and spoils the beer. Another problem is that the filling of the beer directly into the bag has been known to rupture the bag.

### SUMMARY OF THE INVENTION

It is an object of the present invention to provide a method for filling a bag with an alcohol beverage or beer that reduces the risk of the bag retaining air when the beverage is filled into the bag.

It is another object of the present invention to provide a method for filling a bag with an alcohol beverage or beer that reduces the chances of bag rupture during filing of the bag with the beverage.

It is an object of the present invention to provide a valve assembly for use with an alcohol beverage or beer dispensing apparatus that reduces the risk of the bag retaining air when filled with beer.

It is another object of the present invention to provide a single valve assembly that fits through a single opening for the container of an alcohol beverage or beer dispensing apparatus.

It is another object of the present invention to provide a valve assembly for an alcohol beverage or beer dispensing apparatus which assembly is adapted to fill the bag with an alcohol beverage or beer and is adapted to supply a pressure in the container against the bag for dispensing the alcohol from the bag, and reduces the chances of the bag rupture during filing of the bag.

It is another object of the present invention to provide a valve and spear unit assembly for use with an alcohol beverage or beer dispensing apparatus that reduces the risk of the bag retaining air when filled with beer, which assembly is a separate component part of the alcohol dispensing apparatus that may be cleaned and recycled.

It is yet another object of the present invention to provide a valve and spear assembly for an alcohol beverage or beer dispensing apparatus that is adapted to fill the bag with an alcohol beverage and is adapted to supply a pressure in the container against the bag for dispensing the alcohol from the bag, and reduces the chances of the bag rupture during filing of the bag.

In one aspect, the present invention provides a method for filling a bag with an alcohol beverage wherein the bag is inflated with an inert gas prior to filing the bag with the beverage and the inert gas is vented from the bag, preferably as the bag is filled with the beverage.

By initially inflating the bag with the inert gas, the bag does not have to be inflated during the step of filling the bag with the beverage and hence the bag is less susceptible to rupture during beverage filling. Further the inert gas does not adversely react with the beverage to spoil the beverage. Also, inflating the bag with inert gas acts to purge or mix any air trapped against in the bag with the inert gas and during the venting step, the air is vented from the bag with the inert gas. As a consequence, there is less chance for air to be trapped in the bag and spoil the beverage in the bag. Preferably, the inert gas is vented from the bag during the step of filling the inflated bag with the beverage.

In another aspect, the present invention provides a method for filling a bag contained in a container with an alcohol beverage wherein air located between the bag and container is evacuated from the container. The bag is then inflated with an inert gas prior to filling the bag with the beverage and the inert gas is vented from the bag as the bag is filled with the beverage.

By initially evacuating air from the container prior to bag inflation, the present invention reduces the occurrence of air pockets being trapped between the bag and container during bag inflation. Further, the inflation of the bag requires less pressure thereby reducing stress placed on the bag during inflation and hence reducing risk of bag rupture. Alternatively, if the gas is inserted into the bag under at a non-lessened pressure, the fill rate of the bag is not slowed down by venting of air from the container because the air has already been evacuated. These advantages may be further enhanced by continuing the evacuating step during the bag inflation step.

It should be understood that by evacuating air from the container it is meant to reduce the volume of air in the container outside of the bag and in effect create a vacuum in the container that facilitates the inflation of the bag with the inert gas.

By inert or charging gas, it is meant a gas that has an inert chemical reaction when mixed with the alcohol beverage so as not to spoil or adversely affect the quality of the beverage. Preferably the inert gas is CO₂ or nitrogen when the beverage is beer.

In accordance with another aspect of the present invention there is provided a valve assembly adapted for filling a bag with an alcohol beverage where the bag is contained in a container having an aperture. The valve assembly comprises a valve body adapted to be secured in the aperture. In one embodiment, the valve body has a first passageway extending through the center of the valve body. The valve body has at least one second passageway extending through the valve body radially spaced from the first passageway. The assembly has a first valve centrally seated in the valve body in releasable sealing engagement with the first passageway for controlling the flow of one of charging gas and beverage through the first passageway into and out of the bag. The assembly has a second valve seated in the valve body concentrically of the first valve in releasable sealing engagement with the at least one second passageway for controlling the flow of one of charging gas and beverage through the at least one second passageway into and out of the bag.

It is envisaged that the valve body has at least one and third passageway spaced radially out from the first passageway and the assembly has a third valve seated in the valve body concentrically of the first valve for controlling the flow of gas through the at least one third passageway into and out of the container exterior of the bag. The third valve permits air to be removed from the keg container as the bag is inflated and permits for pressurized air to be forced into the container and act against the bag to facilitate beverage dispensing. This embodiment has three valves utilized in one valve body.

Preferably, the second and third valves are ring valves that are concentrically spaced to provide valve actuators for opening and closing the valve that are radially spaced from each other and axially moveable independent of each other.

In a second embodiment, the valve body has first, second and third spaced apart passageways extending through the valve body. The valve assembly has first, second and third valves. The first valve is seated in the first passageway for controlling the flow of one of charging gas, preferably CO₂, and beverage through the first passageway, into and out of the bag. The second valve is seated in the second passageway for controlling the flow of one of charging gas and beverage through the second passageway, into and out of the bag. The third valve is seated in the third passageway for controlling the flow of gas through the third passageway, into and out of the container exterior of the bag.

By providing an extra valve, i.e. two valves that permit for charging gas, the bag may be inflated with the charging gas prior to filling with beer. The use of the charging gas reduces the risk of bag rupture when the beverage is filled into the bag. When the alcohol beverage is filled into the inflated bag, the inert charging gas and any air mixed therewith, is forced out the valve not used to fill the bag with the beverage.

Preferably, the first valve is used to fill and dispense the alcohol beverage from the bag. Preferably, the second valve is used to inflate the bag with charging gas and permit the charging gas to exit the bag as the bag is filled through the first valve with the alcohol beverage.

Each valve may have a valve actuator for opening and closing the valve. Preferably, the valve actuator of each valve extends away from the valve body by a different predetermined distance. This permits for selective activation of the valves either one at a time or in set combinations during inert gas filling, alcohol filling and alcohol dispense mode of operation. Preferably, the first passageway is centrally disposed of the valve body and the other two passageways are spaced radial thereof.

Therefore, in accordance with another aspect of the present invention there is provided a valve assembly adapted for filling a bag with an alcohol beverage where the bag is contained in a container having an aperture. The valve assembly comprises a valve body adapted to be secured in the aperture. The valve body has a first passageway extending through the center of the valve body and at least one second passageway extending through the valve body radially spaced from the first passageway. The valve assembly has a first valve centrally seated in the valve body in releasable sealing engagement with the first passageway for controlling the flow of one of charging gas and beverage through the first passageway into and out of the bag. The valve assembly has a second valve seated in the valve body concentrically of the first valve in releasable sealing engagement with the at least one second passageway for controlling the flow of one of charging gas and beverage through the at least one second passageway into and out of the bag.

In accordance with a further aspect of the present invention there is provided a valve and spear assembly or unit for use with a container housing a bag adapted to be filled with an alcohol beverage. The valve and spear assembly comprises a valve body having first, second and third spaced apart passageways extending through the valve body. The assembly has a first valve seated in the first passageway for controlling the flow of one of charging gas and beverage through the second passageway. The assembly has a second valve seated in the second passageway for controlling the flow of one of charging gas and beverage through the first passageway. The assembly has a third valve seated in the third passageway for controlling the flow of pressurizing gas through the third passageway. The assembly has an elongated hollow spear extending from and connected in fluid flow communication with the first passageway. The hollow spear has an open end portion spaced from the first passageway. By providing a separate component part comprising the valve and spear unit assembly, there is provided a part that may be removed from the container, cleaned and re-used.

Preferably, the first passageway has a tubular extension extending from the valve body that is adapted to extend into the bag, and the hollow spear is secured to the tubular extension.

Preferably, the spear has an outside diameter and the hollow tube extension has an inside diameter corresponding to the outside diameter of the spear whereby the spear is inserted into the hollow tubular extension by interference fit.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus;

FIG. 3 is broken away perspective view of the keg showing the valve and spear assembly mounted within the keg;

FIG. 4 is a sectional side view of the valve and spear assembly as shown in FIG. 3;

FIG. 5 is a perspective view of the valve and spear assembly outside of the keg;

FIG. 6 is a plan view of the valve body of the valve assembly; and,

FIGS. 7, 8, 9, 9a and 10 are simplified sectional views of the valve body showing valve operation.

FIG. 11 is an exploded view of the valve and spear assembly with the keg of the present invention;

FIG. 12 is a sectional side view of the valve and spear assembly as shown in FIG. 11;

FIG. 13 is a sectional side view of an alternative valve and spear assembly.

### DETAILED DESCRIPTION OF THE INVENTION

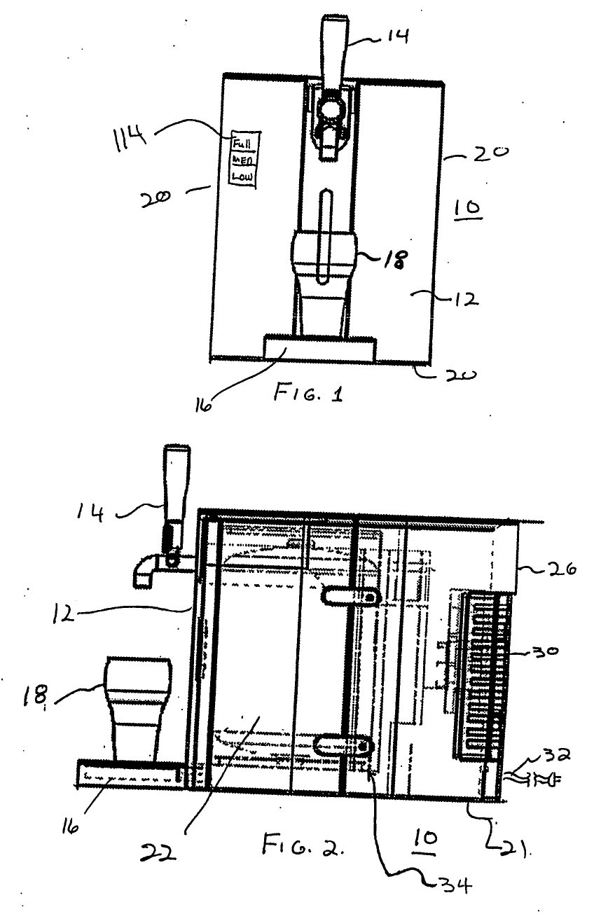

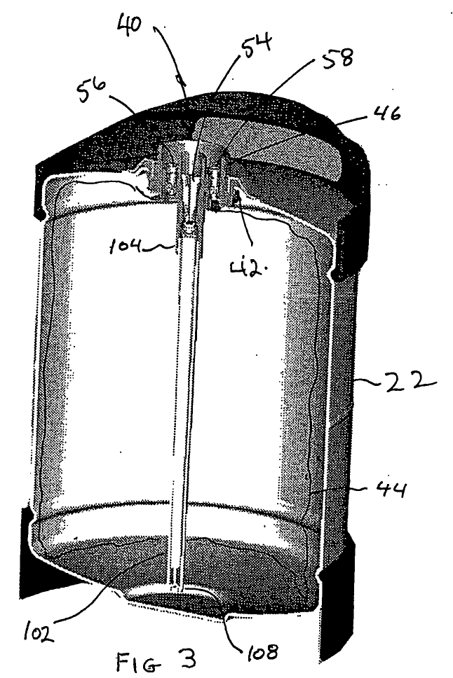

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top. The front wall 12 is an extension of two pivoting side walls 20 which may be moved between closed and open positions to allow the keg 22 (see FIG. 2 in broken lines) to be inserted into the housing of the home beer dispensing apparatus 10.

The housing of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the unit 10. Alternatively, a 12 Volt DC supply input may be used.

The dispensing apparatus 10 has a cooling system 34 located behind and below keg 22 that is adapted to cool beer in keg 22 when keg 22 is placed into dispensing apparatus 10

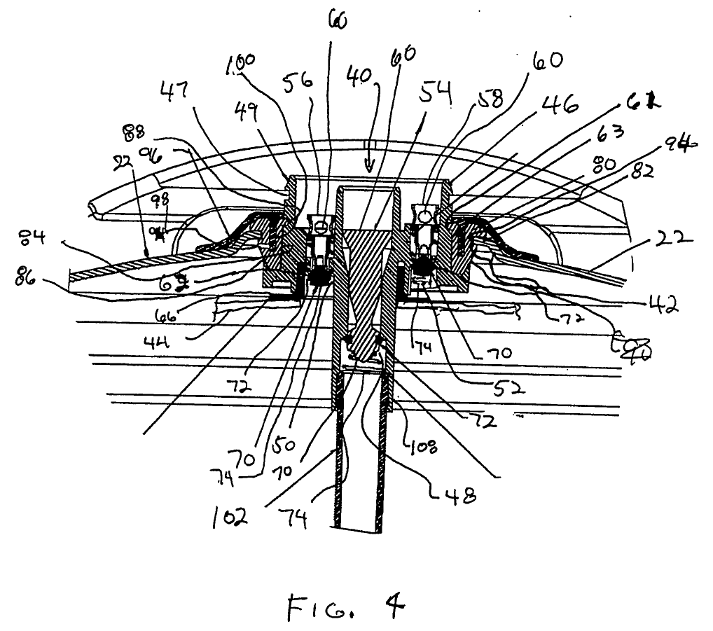

Referring now to FIGS. 3 through 6, the valve assembly 40 and spear 102 are shown.

The valve assembly 40 is adapted to fit into a raised collar aperture 42 of keg 22. The valve assembly 40 has an annular shaped body 46 that is secured in the aperture 42. The valve body 46 has an annular groove 47 and flange 49 that is adapted to extend above the keg 22 for mating with a tap dispensing adapter (not shown) connected to tap 14 (see FIGS. 1 and 2).

The valve body 46 has a first passageway 48, a second passageway 50, and a third passageway 52 spaced apart from each other and extending through the valve body 46. As best seen in FIG. 6, the first passageway 48 is centrally disposed or located within the valve body 46 and the second and third passageways 50, and 52 are spaced radially of the first central passageway 48.

The valve assembly includes a first valve 54, a second valve 56 and a third valve 58. The first valve 54 is seated in the first passageway 48 for controlling the flow of the beverage or beer through the first passageway 48 into and out of the bag 44.

The second valve 56 is seated in the second passageway 50 for controlling the flow of gas such as carbon dioxide through the second passageway 50 into and out of the bag.

The third valve 58 is seated in the third passageway 52 and controls the flow of gas through the third passageway 52 into and out of the keg 22 exterior to the bag 44.

Each valve, 54, 56, and 58 has a valve actuator or stem 60 that effectively opens and closes the valve. The valve stem 60 extends away from the valve body 46 by a different predetermined distance for each of valves 54, 56 and 58. Each of the valves 54, 56 and 58 further includes a valve head 70 connected to the valve stem 68. The valve head 70 carries an O-ring 72 which is adapted to seal the valve head within the respective passageway. A spring 74 urges the valve head 70 into sealing engagement with its corresponding passageway. The valve stems 68 are accessible from outside the keg 22 for moving each valve head 70 into an open and closed position to respectively enable and inhibit fluid flow through passageways 48, 50 and 52.

The valve body 46 has an annular recessed groove 62 recessed in an inner wall 64 of the valve body 46. The inner wall 64 is positioned within the keg 22. The recessed groove 62 is adapted for receiving the neck 66 of bag 44 in press fit relation therewith. The annular recessed groove 62 has a diameter that surrounds the first and second passageways 48 and 50. The third passageway 52 is located outside of the diameter of the recessed groove 62 and as a result, the third passageway 52 is located outside of the bag 44.

The keg 22 has a collar flange 82 which defines the raised collar aperture 42, the valve body 46 has an outer peripheral wall 63 with a recessed groove 61 extending around the outer wall 63. An intermediate ring or bung 80 is adapted to seat the valve body 46 within the raised collar aperture 42. The intermediate ring 80 has inner and outer walls 84, 86. The inner wall 84 has flange 88 extending inwardly thereof that is adapted to fit into the recessed groove 61 of the outer wall 63 of the valve body 46. The outer wall 86 of the intermediate ring 80 has a resilient barb 90 and a locking flange 92 spaced from the barb 90 so as to define an outer locating groove 94 into which the collar flange 82 of the keg 22 is held. The barb 90 is adapted to pass through the aperture 42 and spring back into locking engagement with the collar flange 82 so as to lock the valve assembly 40 in place. Special tools are required to remove the valve assembly 40 and the intermediate ring 80 from the collar flange 82 of the keg 22 once the keg 22 is returned to the brewery for refilling.

In order to ensure that the contents of the keg 22 have not been tampered with, the keg 22 has an anti-tamper ring 96 that overlays the intermediate ring 80, a portion of the keg 22 and a portion of the valve body 46. The intermediate ring 80 has an aperture 98 that passes completely through the intermediate ring 80 to provide a vent passageway. The anti-tamper ring 96 has a flange part 100 that is inserted into the vent aperture 98 of the intermediate ring 80. In the event the anti-tamper ring 96 is removed from the keg 22, vent aperture 98 is open and the contents or any pressure within the keg 22 exterior of the bag is released. Further, as a pressure relief feature, the anti-tamper ring 96 is designed to release from aperture 98 when pressure in keg 22 exceeds a predetermined valve to vent pressurized air through aperture 98.

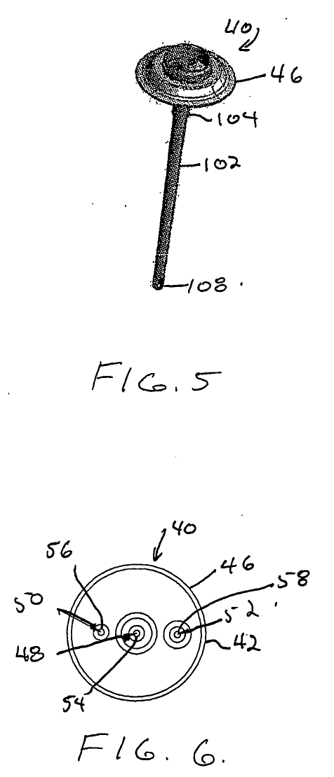

The valve assembly 40 and the spear assembly 102 provide a combination that may be removed for the purposes of recycling of the valve assembly 40 and the spear assembly 102. The bag neck 66 can be removed from the valve assembly 40 so that this valve 40 and spear 102 assembly may be cleaned and reused with a new bag 44 and bag neck 66. The valve and spear assembly is shown as an independent assembly in FIG. 5. In order to accommodate the spear 102, the first passageway 48 of the valve body 46 has a tubular extension 104 that extends downwardly or outwardly from the inner wall 64 of the valve body 46. The spear 102 comprises an elongated hollow tube which may have rounded bottom edges or bottom and aperture end 108 that extends the spear and the first passageway 48 of the valve body 46 towards the bottom of the keg 22 and the bottom of the bag 44. The hollow spear 22 has an outside diameter that fits inside the diameter of the tubular extension 104 of the first passageway 48 in an interference type of fit whereby the two parts may be secured together. The interference fit may be a tapering effect between the outer wall of the spear 102 and the inner wall of the tubular extension 104. Alternatively, a snap fit may be utilized.

Referring to FIG. 7, the valve assembly 40 is shown with each of its first, second and third valves 54, 56 and 58 in a closed position. The valve stems 68 of each valve 54, 56 and 58 extends a different distance upwardly so that it may be activated in a selective manner described in relation to the method of filling the bag 66 with beer or alcohol beverage.

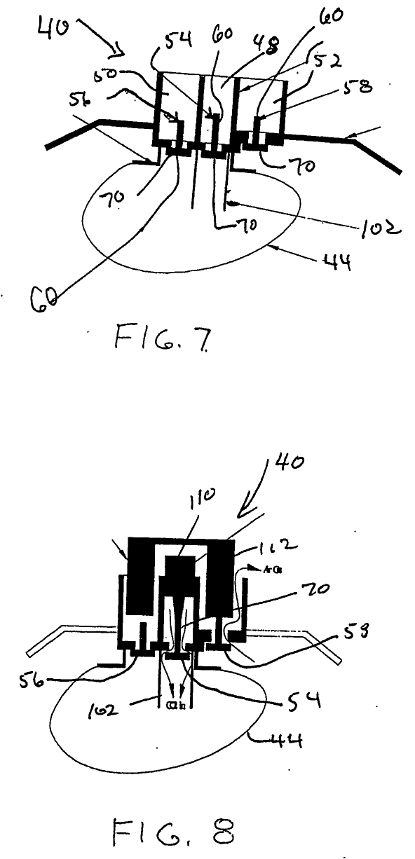

Referring to FIG. 8, the valve assembly 40 is shown secured to the keg 22 with the bag 44 illustratively shown in a smaller circle within the keg 22. Initially, the bag is deflated when the valve assembly 40, spear 102 and bag 44 are inserted into the keg 22. Next, an engagement ring 110 engages the actuator 70 of the first valve 54 and at the same time an engagement ring 112 engages the actuator 70 of the third valve 58. At this stage, carbon dioxide is blown in through the first valve passageway 48 because the first valve 54 is opened by the engagement ring 110. The carbon dioxide inflates the bag 44 such that the bag is inflated to fill the volume of the keg 22. Further, the carbon dioxide mixes with air trapped in bag 10.

As the bag 44 expands within the container 22 air trapped between the bag 44 and the keg 22 exits through the third passageway 52 because the third valve 58 is open.

In an alternative embodiment prior to the carbon dioxide being blown through passageway 48, third valve 58 is opened and third passageway 52 is connected to a vacuum pump (not shown) which draws a vacuum through third passageway 52 to evacuate air trapped in the keg 22 outside of the bag and creates a partial vacuum in the keg 22. Then, as before, the engagement ring 110 opens first valve 54 and carbon dioxide is blown under pressure in through the first valve passageway 48. The carbon dioxide inflates the bag 44 such that the bag is inflated to fill the volume of the keg 22. Further, the carbon dioxide mixes with air trapped in bag 10. Due to the previous evacuation of air from the keg 22, the bag 44 readily expands within the keg 22. Alternatively, the step of evacuating the air from keg 22 may continue during the step of filling the bag 44 with carbon dioxide.

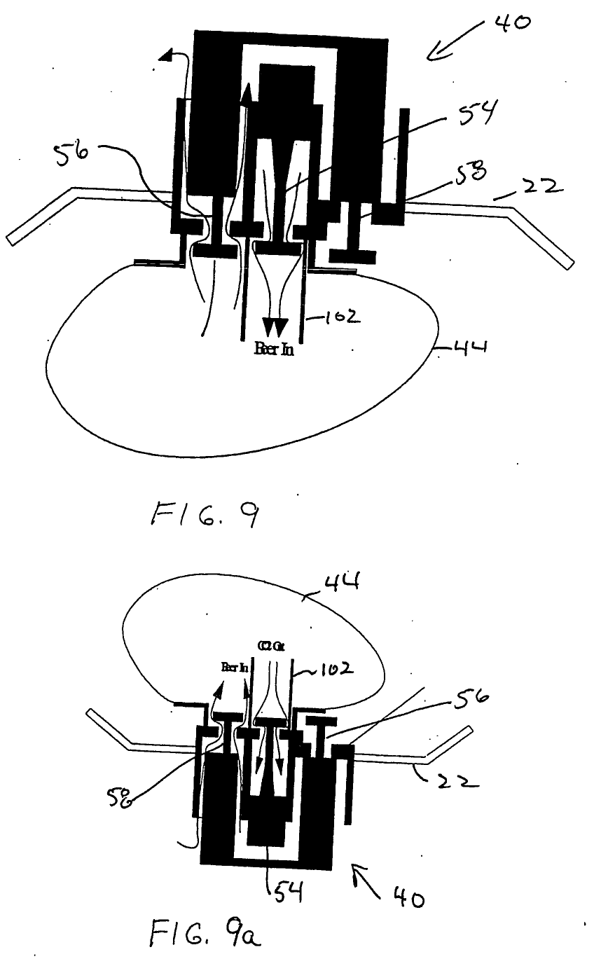

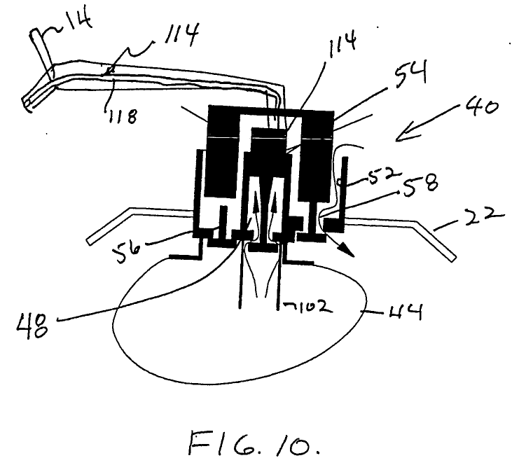

Referring to FIG. 9, the next step is to insert or fill the bag 44 with beer. Preferably, the larger valve or central valve is used. That is the first valve 54 is opened and at the same time the second valve 56 is opened. In this embodiment, the beer will go in through the first passageway 48 and the carbon dioxide will exit through the second passageway 50 removing any air mixed with the carbon dioxide gas.

Referring to FIG. 9A, an alternative arrangement is shown where the bag 44 is loaded with beer in an inverted position. In this position, the smaller valve or second valve 56 is used to insert the beer into the container and the first valve 54 is used to permit the carbon dioxide to exit the bag 44.

The next step is the dispensing step which is shown in FIG. 10. An adapter or keg adapter 114 is mounted onto the valve assembly 40 to open valves 54 and 58 such that a dispensing tube 118 is connected to the first passageway 48 whereby when dispense tap 14 opens, the beer flows up through hollow spear 102 and out the first passageway 48 to the tap 14. At the same time, in order to facilitate this flow of beer, the exterior wall of the bag 44 is pressurized. This is done by a pressure system (not shown) which is attached to the third passageway 52 and with the third valve 58 open to permit pressurized air to enter through the third passageway 52.

The different predetermined heights or extensions of the valve actuator 60 of each of the first, second and third valves 54, 56 and 58 permits for different valves to be actuated or opened by the dispenser ring in a selective manner.

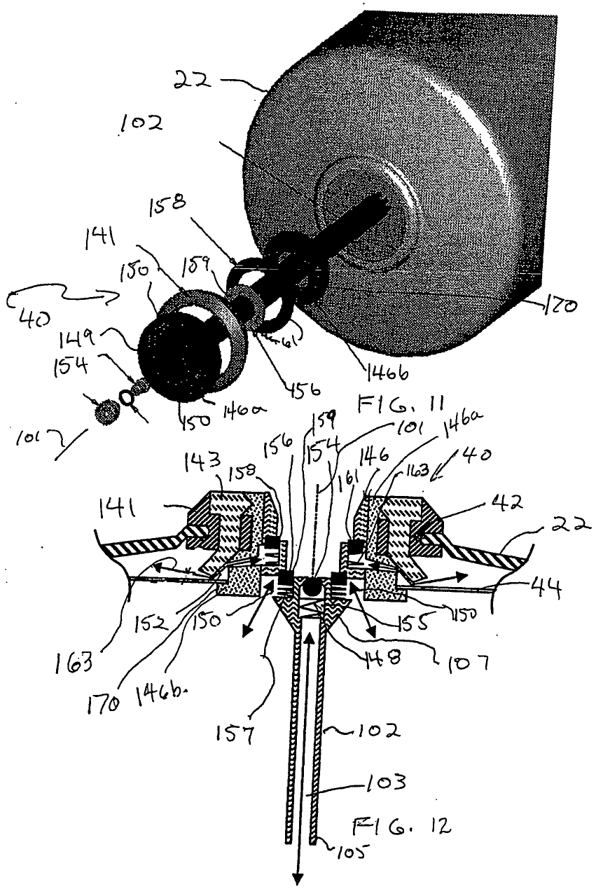

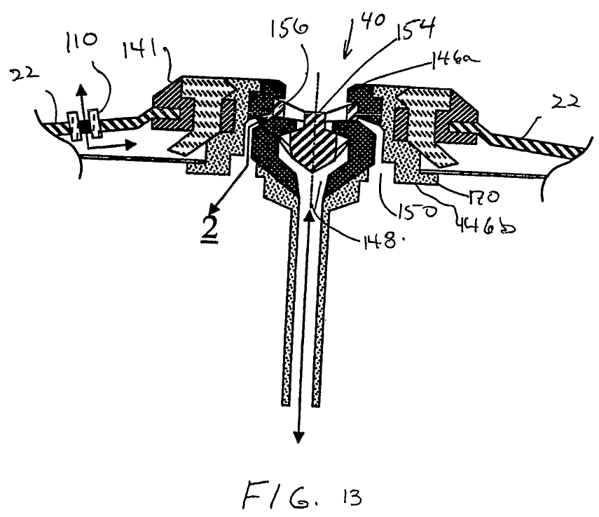

Referring now to the embodiment of FIGS. 12 and 13, the valve assembly 40 and spear 102 are shown. The valve assembly 40 is adapted to fit into a raised collar aperture 42 of keg 22. The valve assembly 40 has an annular shaped body 146 that is secured in the aperture 42 through a bung 41 and locking member 143. The valve body 146 has an annular flange 149 (see FIG. 11) that is adapted for mating with a tap dispensing adapter (not shown) connected to tap 14 (see FIGS. 1 and 2) for dispensing the beverage from keg 22.

The valve body 146 has a first centrally disposed passageway 148. The first centrally disposed passageway 148 contains a first valve 154 in the form of a ball that is movable within the passageway 148. The ball valve 154 is held in normally sealing engagement by spring 155. The first passageway 48 is connected and forms part of the hollow spear 102. The spear has a central passageway 103 along which beverage or charging gas may be moved to a remote end 105 positioned adjacent the bottom of keg 22.

The valve body 146 has a second passageway 150 that is shown readily spaced outwardly of the first passageway 148. It should be understood from FIG. 12, two passageways 150 are shown diametrically opposed to each other on opposing radial sides of the central aperture 148. As shown in FIG. 11, this comprises two passageways 150. It should be understood that only one passageway is required so long as the passageway is radially spaced from the first passageway 148. The second passageway 150 is closed by a second valve 156 which comprises a circular or annular flat ring shaped valve. The valve 156 is held in sealing engagement within the valve body 146 by means of spring 157. Spring 157 is seated against the head 107 of spear 102 and is adapted to force the flat valve or second valve 156 into sealing engagement across its aperture 150. The flat seal 156 provides for an actuator surface 159 that is radially spaced from the center valve 154 and is axially moveable parallel to axis 101 independent of the axial movement of the ball valve 154.

The valve body 146 further includes at least one third passageway 152. The passageway 152 is shown to be readily spaced and disposed relative to the central passageway 103. The radial passageway 152 is closed by a third ring valve 158. The third ring valve 158 is held in its closed position by a spring 163 that acts against an intermediate wall between the second passageway 150 and the third passageway 152 to maintain the valve 58 in a sealing closed position. The valve 58 has a ring shaped actuator surface 161 that is spaced concentrically and radially of the first and second valves 154 and 156 so as to be independently moveable relative to these valves parallel to axis 101.

The first valve or ball valve 154 is moveable to control the flow of a charging gas or the beer beverage into and out of the bag 44. The second valve 156 also controls the flow of either the charging gas or beverage into or out of the bag 44. In the preferred embodiment, the charging gas is controlled by the second valve 156 and the flow of beverage is controlled by the first valve 154.

The third valve 158 is seated in the third passageway 152 and is open to permit air as shown by arrows 63 to be forced into the keg 22 exterior to the bag 44.

The valve body 146 in effect acts as the bag neck for bag 44 and comprises two parts 146a and 146b that are snap fitted together to securely locate flap valves 156 and 158 therebetween. To support the bag 44, neck or valve body part 46b has an out turned annular flange 170 having a diameter that is greater than the diameter of the second passageway 150. The bag 44 is welded to the out turned annular flange 170 whereby the bag 44, valve assembly 40, and spear 102 become a disposable assembly.

Referring to FIG. 13, there is shown an embodiment similar to FIG. 4 in that the valve assembly 40 comprises a first valve 154 and a second valve 156. However, the difference is that the third valve is now valve 110 which is located in a top wall of the keg 22.

Referring to FIG. 12, during assembly and filling of the keg 22 with beer, the spear 102 and valve assembly 40 together with bag 44 are inserted through the keg aperture 42 of the keg 22. The valve assembly 40 is mounted in place by the bung 141 and interlocking fingers 143. Next, the bag 44 is preferably filled with carbon dioxide gas through opening of valve 156. This inflates the bag 44 within the keg 22. At the same time, the air valve 158 is opened to permit air to escape from the keg 22 as the bag 44 inflates to fill the space within the keg 22.

After the bag 44 has been filled with carbon dioxide gas, any air trapped within the bag should be mixed with the carbon dioxide gas. The next step is to insert beer into the inflated bag 44 along spear 102. This is accomplished by connecting a hose to the first valve 154 so as to open the valve 54 and then insert beer in through valve 154 and spear 102 into the bag 44. The hose also effectively opens valve 156 and allow gas to escape out through valve 156 as the beer fills the contents or the volume of the bag 44.

During beer dispensing, an adapter tap (not shown) is secured to the valve assembly 40 in a manner that will interconnect the spear 102 with the tap 14 whereby when the tap 14 FIG. 1) is actuated, beer is dispensed from the bag 44 along spear 102 up through valve 154 to tap 14. At the same time, a supply of pressurized air is provided through air valve 158. If the embodiment of FIG. 13 is used, then the air is provided through valve 110 in a top wall of keg 22. The pressurized air is forced against the outer surface of bag 44 to push or force beer out along spear 102 through valve 154 and out tap 14.

What is claimed is:

1. A method for filling a bag with an alcohol beverage comprising the steps of:
inflating the bag with an inert gas for the beverage;
filling the inflated bag with the beverage; and,
venting the inert gas from the bag.

2. The method of claim 1 wherein the inert gas is CO₂.

3. The method of claim 1 wherein the beverage is beer.

4. The method of claim 1 wherein the inert gas is vented from the bag during the step of filling the inflated bag with the beverage.

5. A method of filling and dispensing an alcohol beverage from a bag contained in a container, the method comprising the steps of:
inflating the bag with an inert gas selected from gasses that do not adversely react with the beverage;
filling the inflated bag with the beverage;
venting the inert gas from the bag; and,
applying a gas under pressure into the container against the bag to facilitate dispensing of the beverage from the bag.

6. The method of claim 5 wherein the inert gas is CO₂.

7. The method of claim 5 wherein the beverage is beer.

8. The method of claim 5 wherein the inert gas is vented from the bag during the step of filling the inflated bag with the beverage.

9. The method of claim 5 wherein the step of inflating the bag inflates the bag to a volume corresponding to that of the container.

10. The method of claim 9 wherein the step of inflating the bag brings the bag into contact with inside walls of the container.

11. The method of claim 5 wherein the container is a beer keg that supports the bag relative thereto.

12. A method of filling an alcohol beverage into a bag contained in a container, the method comprising the steps of:
evacuating the container of air located between the container and the bag;
inflating the bag with an inert gas selected from gasses that do not adversely react with the beverage;
filling the inflated bag with the beverage; and,
venting the inert gas from the bag.

13. The method of claim 12 wherein the step of evacuating the bag of air continues during the step of inflating the bag with an inert gas.

14. The method of claim 12 wherein the inert gas is CO₂.

15. The method of claim 12 wherein the beverage is beer.

16. The method of claim 12 wherein the inert gas is vented from the bag during the step of filling the inflated bag with the beverage.

17. The method of claim 12 wherein the step of inflating the bag inflates the bag to a volume corresponding to that of the container.

18. The method of claim 12 wherein the step of inflating the bag brings the bag into contact with inside walls of the container.

19. The method of claim 12 wherein the container is a beer keg that supports the bag relative thereto.

20. A method of filling an alcohol beverage into a bag contained in a container having a valve system mounted with the bag and container, and the valve system has first, second and third valves, the method comprising the steps of:
evacuating the container of air located between the container and the bag by applying a vacuum to the container through the first valve;
inflating the bag through the second valve with an inert gas selected from gasses that do not adversely react with the beverage;
filling the inflated bag with the beverage through one of the second and third valves; and,
venting the inert gas from the bag through another of the second and third valves.

21. The method of claim 20 wherein the step of evacuating the bag of air continues during the step of inflating the bag with an inert gas.

22. The method of claim 20 wherein the inert gas is CO₂.

23. The method of claim 20 wherein the beverage is beer.

24. The method of claim 20 wherein the inert gas is vented from the bag during the step of filling the inflated bag with the beverage.

25. The method of claim 20 wherein the step of inflating the bag inflates the bag to a volume corresponding to that of the container.

26. The method of claim 20 wherein the step of inflating the bag brings the bag into contact with inside walls of the container.

27. The method of claim 20 wherein the container is a beer keg that supports the bag relative thereto.

28. A valve and spear assembly for use with a container housing a bag adapted to be filled with an alcohol beverage, the valve and spear assembly comprising:
a valve body having first, second and third spaced apart passageways extending through the valve body;
a first valve seated in the first passageway for controlling the flow of one of charging gas and beverage through the first passageway;
a second valve seated in the second passageway for controlling the flow of one of charging gas and beverage through the first passageway;
a third valve seated in the third passageway that is for controlling the flow of pressurizing gas through the third passageway; and,
an elongated hollow spear extending from and connected in fluid flow communication with the first passageway, the hollow spear having an open end portion spaced from the first passageway.

29. The valve and spear assembly of claim 28 wherein the first passageway has a tubular extension extending from the valve body and adapted to extend into the bag, and wherein the hollow spear is secured to the tubular extension.

30. The valve and spear assembly of claim 29 wherein the hollow spear is secured to the tubular extension by interference fit.

31. The valve and spear assembly of claim 30 wherein the spear has an outside diameter and the hollow tube extension has an inside diameter corresponding to the outside diameter of the spear whereby the spear is inserted into the hollow tubular extension by interference fit.

32. The valve and spear assembly of claim 28 wherein each valve has a valve actuator for opening and closing the valve that extends away from the valve body and container by a different predetermined distance permitting for selective actuation of the actuators.

33. The valve and spear assembly of claim 28 wherein one of the first, second and third passageways is centrally disposed of the valve body and the other two passageways are spaced radial thereof.

34. The valve and spear assembly of claim 33 wherein the first passageway is the one passageway that is centrally disposed of the valve body.

35. The valve and spear assembly of claim 33 wherein each valve has a valve actuator for opening and closing the valve that extends away from the valve body and container by a different predetermined distance.

36. The valve and spear assembly of claim 35 wherein the first passageway is the one passageway that is centrally disposed of the valve body.

37. The valve and spear assembly of claim 36 wherein the valve body has an annular shape.

38. The valve and spear assembly of claim 10 wherein the valve body has an annular ring adapted to extend above the container for mating with a dispensing adapter.

39. The valve and spear assembly of claim 37 wherein the valve body has an annular recessed groove positioned within the container for receiving a neck of the bag in press fit relation therewith.

40. The valve and spear assembly of claim 39 wherein the annular recessed groove has a diameter that surrounds the first and second passageways.

41. The valve and spear assembly of claim 36 wherein the valve body has a recessed groove positioned within the container for receiving a neck of the bag in press fit relation therewith.

42. The valve and spear assembly of claim 41 wherein the recessed groove surrounds the first and second passageways.

43. The valve and spear assembly of claim 28 wherein the first, second and third valves each comprise stem valves having a valve piston and a valve head, each said valve stem is accessible from outside the container for moving the valve head into open and closed positions respectively enabling and inhibiting fluid flow through a respective passageway in the valve body.

44. The valve and spear assembly of claim 43 wherein each valve head carries an o-ring for sealing against a surface of the respective passageway in the valve body and a spring seated in the respective passageway for urging the valve head into a closed position.

45. The valve and spear assembly of claim 43 wherein each valve stem extends a different predetermined distance from the valve body to permit for selective actuation of the valves.

46. A container provided with a valve and spear assembly as claimed in any one of claims 28 to 45.

47. A valve assembly adapted for filling a bag with an alcohol beverage where the bag is contained in a container having an aperture, the valve assembly comprising:
a valve body adapted to be secured in the aperture, the valve body having first, second and third spaced apart passageways extending through the valve body;
a first valve seated in the first passageway for controlling the flow of one of charging gas and beverage through the first passageway into and out of the bag;
a second valve seated in the second passageway for controlling the flow of one of charging gas and beverage through the second passageway into and out of the bag; and,
a third valve seated in the third passageway for controlling the flow of gas through the third passageway into and out of the container exterior of the bag.

48. The valve assembly of claim 47 wherein each valve has a valve actuator for opening and closing the valve, and the valve actuator extending away from the valve body by a different predetermined distance.

49. The valve assembly of claim 47 wherein one of the first, second and third passageways is centrally disposed of the valve body and the other two passageways are spaced radially thereof.

50. The valve assembly of claim 49 wherein the first passageway is the one passageway that is centrally disposed of the valve body.

51. The valve assembly of claim 49 wherein each valve has a valve actuator for opening and closing the valve, and the valve actuator extending away from the valve body by a different predetermined distance.

52. The valve assembly of claim 51 wherein the first passageway is the one passageway that is centrally disposed of the valve body.

53. The valve assembly of claim 52 wherein the valve body has an annular shape.

54. The valve assembly of claim 53 wherein the valve body has an annular ring adapted to extend above the container for mating with a dispensing adapter.

55. The valve assembly of claim 53 wherein the valve body has an annular recessed groove positionable within the container for receiving a neck of the bag in press fit relation therewith.

56. The valve assembly of claim 55 wherein the annular recessed groove has a diameter that surrounds the first and second passageways.

57. The valve assembly of claim 47 wherein the valve body has a recessed groove positioned within the container for receiving a neck of the bag in press fit relation therewith.

58. The valve assembly of claim 57 wherein the recessed groove surrounds the first and second passageways.

59. The valve assembly of claim 47 wherein the first, second and third valves each comprise stem valves having a valve piston and a valve head, each said valve stem is accessible from outside the container for moving the valve head into open and closed positions respectively enabling and inhibiting fluid flow through a respective passageway associated with the valve body.

60. The valve assembly of claim 59 wherein each valve head carries an o-ring for sealing against a surface of the respective passageway in the valve body and a spring seated in the respective passageway for urging the valve head into a closed position.

61. The valve assembly of claim 59 wherein each valve stem extends a different predetermined distance from the valve body.

62. A container provided with a valve assembly as claimed in any one of claims 46 to 60.

63. An alcohol beverage dispensing apparatus comprising:
a keg having an aperture;
a bag contained in the keg for containing an alcohol beverage; and,
a valve assembly comprising:
a valve body secured in the aperture of the keg, the valve body having first, second and third spaced apart passageways extending through the valve body;
a first valve seated in the first passageway for controlling the flow of one of charging gas and beverage through the first passageway into and out of the bag;
a second valve seated in the second passageway for controlling the flow of one of charging gas and beverage through the second passageway into and out of the bag; and,
a third valve seated in the third passageway for controlling the flow of a pressurizing gas through the third passageway into the container and exterior of the bag.

64. The dispensing apparatus of claim 63 wherein each valve has a valve actuator for opening and closing the valve that extends away from the valve body and out from the container by a different predetermined distance.

65. The dispensing apparatus of claim 63 wherein one of the first, second and third passageways is centrally disposed of the valve body and the other two passageways are spaced radial of thereof.

66. The dispensing apparatus of claim 65 wherein the first passageway is the one passageway that is centrally disposed of the valve body.

67. The dispensing apparatus of claim 65 wherein each valve has a valve actuator for opening and closing the valve that extends away from the valve body and container by a different predetermined distance.

68. The dispensing apparatus of claim 67 wherein the first passageway is the one passageway that is centrally disposed of the valve body.

69. The dispensing apparatus of claim 68 wherein the valve body has an annular shape.

70. The dispensing apparatus of claim 69 wherein the valve body has an annular ring adapted to extend above the container for mating with a dispensing adapter.

71. The dispensing apparatus of claim 69 wherein the valve body has an annular recessed groove positioned within the container for receiving a neck of the bag in press fit relation therewith.

72. The dispensing apparatus of claim 71 wherein the annular recessed groove has a diameter that surrounds the first and second passageways.

73. The dispensing apparatus of claim 63 wherein the valve body has a recessed groove positioned within the container for receiving a neck of the bag in press fit relation therewith.

74. The dispensing apparatus of claim 73 wherein the recessed groove surrounds the first and second passageways.

75. The dispensing apparatus of claim 63 wherein the first, second and third valves each comprise stem valves having a valve piston and a valve head, each said valve stem is accessible from outside the container for moving the valve head into open and closed positions respectively enabling and inhibiting fluid flow through a respective passageway in the valve body.

76. The dispensing apparatus of claim 75 wherein each valve head carries an o-ring for sealing against a surface of the respective passageway in the valve body and a spring seated in the respective passageway for urging the valve head into a closed position.

77. The dispensing apparatus of claim 76 wherein each valve stem extends a different predetermined distance from the valve body.

78. The dispensing apparatus of claim 63 wherein the charging gas is carbon dioxide and the pressurized gas is air.

79. The dispensing apparatus of claim 63 wherein the container has a collar flange defining the container aperture, the valve body has an outer wall with a recessed groove extending around the outer wall, and the valve assembly further comprising an intermediate ring having an inner and outer walls, the inner wall of the intermediate ring having a flange extending inwardly thereof adapted to fit into the recessed groove of the outer wall of the valve body, and the outer wall of the intermediate ring having a resilient barb and spaced locking flange defining an outer groove into which the collar flange of the container is held, and the barb passing through the aperture and springing back into locking engagement with the collar flange to lock the valve assembly in place.

80. The dispensing apparatus of claim 79 wherein the container has an anti-tamper ring overlaying the intermediate ring.

81. The dispensing apparatus of claim 80 wherein the intermediate ring has an aperture into which a flange part of the anti-tamper ring is inserted so that if the anti-tamper ring is removed, the aperture vents the inside of the container outside of bag.

82. A valve assembly adapted for filling a bag with an alcohol beverage where the bag is contained in a container having an aperture, the valve assembly comprising:
a valve body adapted to be secured in the aperture, the valve body having a first passageway extending through the center of the valve body and at least one second passageway extending through the valve body radially spaced from the first passageway;
a first valve centrally seated in the valve body in releasable sealing engagement with the first passageway for controlling the flow of one of charging gas and beverage through the first passageway into and out of the bag; and,
a second valve seated in the valve body concentrically of the first valve in releasable sealing engagement with the at least one second passageway for controlling the flow of one of charging gas and beverage through the at least one second passageway into and out of the bag.

83. The valve assembly of claim 82 wherein the valve body has at least one third passageway spaced radially out from the first passageway and a third valve seated in the valve body concentrically of the first valve for controlling the flow of gas through the at least one third passageway into and out of the container exterior of the bag.

84. The valve assembly of claim 83 wherein the third valve is spaced radially and concentrically out from the second valve.

85. The valve assembly of claim 82 wherein each valve has a valve actuator for opening and closing the valve, and the valve actuators being radially spaced from each other and axially moveable independent of each other.

86. The valve assembly of claim 83 wherein each valve has a valve actuator for opening and closing the valve, and the valve actuators being radially spaced from each other and axially moveable independent of each other.

87. The valve assembly of claim 82 wherein the valve body has an annular shape.

88. The valve assembly of claim 87 wherein the valve body has an annular ring adapted to extend above the container for mating with a dispensing adapter.

89. The valve assembly of claim 82 wherein the valve body has an out-turned annular flange supporting the bag and the out-turned flange having a diameter greater than that of the second passageway.

90. The valve assembly of claim 83 wherein the third passageway through valve body has an inner wall having a out-turned annular flange supporting the bag.

91. The valve assembly of claim 85 wherein the second valve is ring valve.

92. The valve assembly of claim 86 wherein the first and second valves each comprise a ring valve.

93. An alcohol beverage dispensing apparatus comprising:
a keg having an aperture;
a bag contained in the keg for containing an alcohol beverage; and,
a valve assembly comprising:
a valve body adapted to be secured in the aperture, the valve body having a first passageway extending through the center of the valve body and at least one second passageway extending through the valve body radially spaced from the first passageway;
a first valve centrally seated in the valve body in releasable sealing engagement with the first passageway for controlling the flow of one of charging gas and beverage through the first passageway into and out of the bag; and,
a second valve seated in the valve body concentrically of the first valve in releasable sealing engagement with the at least one second passageway for controlling the flow of one of charging gas and beverage through the at least one second passageway into and out of the bag.

94. The dispensing apparatus of claim 93 wherein the valve body has at least one third passageway spaced radially out from the first passageway and a third valve seated in the valve body concentrically of the first valve for controlling the flow of gas through the at least one third passageway into and out of the container exterior of the bag.

95. The dispensing apparatus of claim 94 wherein the third valve is spaced radially and concentrically out from the second valve.

96. The dispensing apparatus of claim 95 wherein the second and third passageways are annular.

97. The dispensing apparatus of claim 93 wherein each valve has a valve actuator for opening and closing the valve, and the valve actuators being radially spaced from each other and axially moveable independent of each other.

98. The dispensing apparatus of claim 94 wherein each valve has a valve actuator for opening and closing the valve, and the valve actuators being radially spaced from each other and axially moveable independent of each other.

99. The dispensing apparatus of claim 98 wherein the valve body has an annular ring adapted to extend above the container for mating with a dispensing adapter.

100. The dispensing apparatus of claim 93 wherein the valve body has an out-turned annular flange supporting the bag and the out-turned flange having a diameter greater than that of the second passageway.

101. The dispensing apparatus of claim 94 wherein the third passageway through valve body has an inner wall having a out-turned annular flange supporting the bag.

102. The dispensing apparatus of claim 97 wherein the second valve is ring valve.

103. The dispensing apparatus of claim 98 wherein the first and second valves each comprise a ring valve.

104. The dispensing apparatus of claim 93 wherein the keg has an air passageway and has an air valve seated in releasable sealing engagement with the air passageway for controlling the flow of air through the air passageway into and out of the keg exterior to the bag.
